(19) United States
(12) Patent Application Publication
(10) Pub. No.: US 2018/0359549 A1
(43) Pub. Date: Dec. 13, 2018

(54) METHOD AND SYSTEM FOR PLAYING SOUND DATA BACKGROUND

(71) Applicant: Nyquest Corporation Limited, Hsinchu City (TW)

(72) Inventors: Ying-Jie HUANG, Hsinchu City (TW); Chih-Hsuan LEE, Hsinchu City (TW)

(73) Assignee: Nyquest Corporation Limited, Hsinchu City (TW)

(21) Appl. No.: 15/780,147

(22) PCT Filed: Nov. 30, 2015
(86) PCT No.: PCT/CN2015/096051

§ 371 Date: May 30, 2018

(51) Int. Cl. H04R 1/06; G06K 19/07; H04B 5/00

(52) U.S. Cl. CPC H04R 1/06; H04R 2420/07; H04B 5/0062; G06K 19/0723

(57) ABSTRACT

A method and a system for playing sound data are provided. The method for playing sound data includes defining a piece of time information, where the time information corresponds to a play time point of a piece of sound data; sending the time information by using a first radio frequency circuit; receiving the time information by using a second radio frequency circuit, and transmitting the time information to a play circuit coupled to the second radio frequency circuit; and playing, by the play circuit, the sound data at the play time point corresponding to the time information.

### BACKGROUND

### Technical Field

The present invention relates to a method for playing sound data, and in particular, to a method for playing sound data by using a radio frequency identification (RFID) transmission technology.

### Related Art

The radio frequency identification (RFID) is a wireless communication technology that can modulate a signal into a frequency-modulated electromagnetic field, to transmit data from an identification attached on an object. According to the presence or absence of power in the radio frequency identification, the radio frequency identification may be classified as passive and active. An integrated circuit in the passive radio frequency identification may be driven by electromagnetic waves sent by a reader. When the identification receives a sufficient signal strength, the identification may send data to the reader. The active identification may actively transmit memory data in the internal identification to the reader at any time by means of internal power.

In daily life, radio frequency identifications have been widely used. For example, during resolution of billing, commodity barcodes are read to calculate the purchase amount; during storage, the commodity barcodes are read to confirm the inventory status, and the commodity barcodes are read when commodities are shipped or put in storage, to confirm the logistics status and baggage classification. Radio frequency identifications are disposed on personnel or objects and are used for tracking and management of inventory and assets, and the banknote and product anti-counterfeiting technologies, and are even implanted in the human body as a personal identity card.

However, data transmitted by current radio frequency identifications does not include time-related information, and even time information is sent by using a radio frequency identification to control a sound play apparatus to play sound data at a specified play time point, or to make different sound play apparatuses capable of synchronously playing sound data.

### SUMMARY

In view of the above, the present invention provides a method and system for playing sound data.

In a first embodiment of a method for playing sound data, the method for playing sound data includes defining a piece of time information, where the time information corresponds to a play time point of a piece of sound data; sending the time information by using a first radio frequency circuit; receiving the time information by using a second radio frequency circuit, and transmitting the time information to a play circuit coupled to the second radio frequency circuit; and playing, by the play circuit, the sound data at the play time point corresponding to the time information.

In a first embodiment of a system for playing sound data, the system for playing sound data includes a first radio frequency circuit, a second radio frequency circuit, and a play circuit that is coupled to the second radio frequency circuit. The first radio frequency circuit is configured to send time information, where the time information corresponds to a play time point of sound data. The second radio frequency circuit is configured to receive the time information sent by the first radio frequency circuit. The play circuit is configured to play the sound data at the play time point corresponding to the time information.

In a second embodiment of a method for playing sound data, the method for playing sound data includes defining a piece of time information, where the time information corresponds to a play time point of a piece of sound data; storing the time information by using a radio frequency identification; reading the radio frequency identification by using a first radio frequency circuit to receive the time information, and transmitting, by the first radio frequency circuit, the time information to a play circuit coupled to the radio frequency circuit; and playing, by the play circuit, the sound data according to the play time point corresponding to the time information.

In a second embodiment of a system for playing sound data, the system for playing sound data includes a radio frequency identification, a first radio frequency circuit, and a play circuit that is coupled to the first radio frequency circuit. The radio frequency identification is configured to store time information, where the time information corresponds to a play time point of sound data. The first radio frequency circuit is configured to read the radio frequency identification to receive the time information. The play circuit is configured to receive the time information, and play the sound data according to the play time point corresponding to the time information.

In a third embodiment of a method for playing sound data, a piece of section information is sent by using a first radio frequency circuit, where the section information corresponds to a play position of the sound data; the section information is received by using a second radio frequency circuit, and the section information is transmitted to a play circuit coupled to the second radio frequency circuit; and the play circuit plays the sound data at the play position corresponding to the section information.

Based on the above, according to the method for playing sound data of the present invention, time information may be sent by using a radio frequency circuit, where the time information corresponds to a play time point of a piece of sound data, so that a play circuit that receives the time information plays the sound data according to any play time point corresponding to the time information, even different play circuits can synchronously play the sound data, thereby improving the convenience in life.

### BRIEF DESCRIPTION OF THE DRAWINGS

The present invention will become more fully understood from the detailed description given herein below for illustration only, and thus are not limitative of the present invention, and wherein:

FIG. 1 is a functional block diagram of a first embodiment of a system for playing sound data according to the present invention;

FIG. 2 is a functional block diagram of a second embodiment of a system for playing sound data according to the present invention;

FIG. 3 is a flowchart of a first embodiment of a method for playing sound data according to the present invention;

FIG. 4 is a flowchart of a second embodiment of a method for playing sound data according to the present invention; and

FIG. 5 is a flowchart of a third embodiment of a method for playing sound data according to the present invention.

### OPTIMAL MANNER FOR IMPLEMENTING THE PRESENT INVENTION

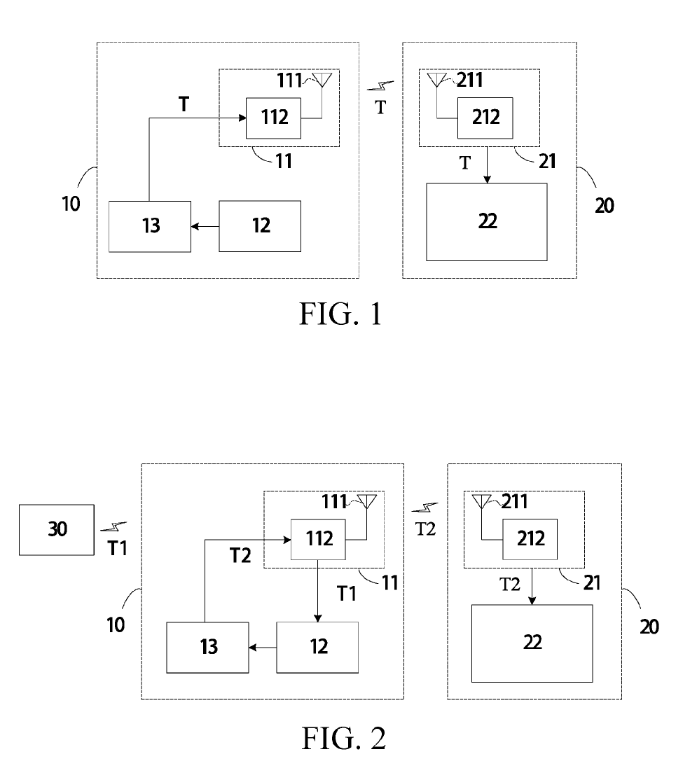

FIG. 1 is a functional block diagram of a first embodiment of a system for playing sound data according to the present invention. Referring to FIG. 1, the system for playing sound data includes two sound play apparatuses (for ease of description, the two sound play apparatuses are respectively referred to as a first sound play apparatus 10 and a second sound play apparatus 20). The first sound play apparatus 10 includes a first radio frequency circuit 11, a first play circuit 12, and a first control circuit 13. The second sound play apparatus 20 includes a second radio frequency circuit 21 and a second play circuit 22.

The first control circuit 13 is coupled between the first play circuit 12 and the first radio frequency circuit 11. The second radio frequency circuit 21 is coupled to the second play circuit 22, and the first radio frequency circuit 11 is coupled to the second radio frequency circuit 21 between the first control circuit 13 and the second play circuit 22 and between the first play circuit 12 and the second play circuit 22.

The first radio frequency circuit 11 sends a piece of time information T. The time information T corresponds to a play time point of a piece of sound data. For example, by using a piece of music having a time length of 5 minutes as an example, the time information T represents any play time point of the sound data within 5 minutes, such as the 0^{th} second, the 2^{nd} second, the 42^{nd} second, the 62^{nd} second, and the 144^{th} second. The second radio frequency circuit 21 receives the time information T sent by the first radio frequency circuit 11, and then transmits the time information T to the second play circuit 22. After receiving the time information T, the second play circuit 22 stores the sound data, and plays the sound data at a play time point, corresponding to the time information T, of the sound data. By using that the play time point corresponding to the time information T may be the 42^{nd} second as an example, the second play circuit 22 starts to play the sound data at the 42^{nd} of the sound data (that is, the second play circuit 22 does not play a sound segment before the 42^{nd} second of the sound data).

In some implementation aspects, the time information T may be a default value. The default time information T is used to control the second play circuit 22 to start to play the sound data at a default play time point of the sound data. During implementation, the first control circuit 13 may be a central processor, a microprocessor, or a microcontroller. The first control circuit 13 may be controlled by using software or firmware to generate the time information T, or the time information T may be pre-stored in a memory, and is transmitted, by using the first control circuit 13, to the first radio frequency circuit 11.

In some implementation aspects, the time information T corresponds to a current play time point of the sound data in the first play circuit 12. That is, the sound data is stored in the first play circuit 12. Before the first radio frequency circuit 11 sends the time information T, the first play circuit 12 is playing the sound data. The first control circuit 13 generates the time information T according to the current play time point of the sound data. The first control circuit 13 detects the current play time point of the sound data in the first play circuit 12, and generates the time information T according to the current play time point of the sound data. That is, the first control circuit 13 may generate, in real time, the time information T corresponding to the play time point of the sound information. For example, when the sound data is played to the 2^{nd} second, the first control circuit 13 may generate the time information T corresponding to the 2^{nd} second, and transmit the time information T to the first radio frequency circuit 11. In this case, if the second radio frequency circuit 21 is located in a communication range of the first radio frequency circuit 11, the second radio frequency circuit 21 receives the time information T corresponding to the 2^{nd} second, so that the second play circuit 22 starts to play the sound data at the 2^{nd} second of the sound data. In this way, the second play circuit 22 and the first play circuit 12 may synchronously play the sound data at a same play time point. During implementation, the first radio frequency circuit 11 includes a first antenna 111 and a modulation module 112. The modulation module 112 performs amplitude modulation or frequency modulation on the time information T generated by the first control circuit 13, and then the first radio frequency circuit 11 sends, by using a first antenna 111, the time information T that belongs to a radio frequency signal. A radio frequency of the time information T sent by the first antenna 111 is less than 30 MHz. The second radio frequency circuit 21 includes a second antenna 211 and a demodulation module 212. The second radio frequency circuit 21 receives the time information T that belongs to the radio frequency signal by using the second antenna 211. The demodulation module 212 demodulates the time information T to obtain the time information T before amplitude modulation or frequency modulation, and transmits the time information T to the second play circuit 22.

The first control circuit 13 includes a counter. The counter counts a current play time point of the sound data in the first play circuit 12, to generate an incremental or decremental count value as the time information T. Specifically, after the first play circuit 12 starts to play the sound data, the counter may count at a fixed frequency to generate a count value, for example, increment or decrement is performed once every 64 ms. After receiving the time information T represented by the count value, the second play circuit 22 may play the sound data according to the play time, corresponding to the count value, of the sound data. Specifically, the second sound play apparatus 20 may further include a plurality of switches or a plurality of multiplexers, and the second play circuit 22 may select a corresponding music segment by using the plurality of switches or plurality of multiplexers according to the count value for play. For example, assuming that a count value 5 corresponds to a music segment, in which a play time point is the 5^{th} second, of the sound data, after receiving the time information T, the second play circuit 22 selects the music segment corresponding to the 5^{th} second, and starts to play the sound data.

In application, by using that the sound data is music as an example, a designer of a sound data play system may store same music in the first play circuit 12 and the second play circuit 22, so that the second play circuit 22 may synchronously play the same music with the first play circuit 12 after receiving the time information T, and the first play circuit 12 and the second play circuit 22 may simultaneously stop playing when the music ends. Alternatively, the first play circuit 12 and the second play circuit 22 may respectively store music having a same melody but different voices, so that the second play circuit 22 may synchronously play the music having the same melody with the first play circuit 12 after receiving the time information T.

FIG. 2 is a functional block diagram of a second embodiment of a system for playing sound data according to the present invention. Referring to FIG. 2, the second embodiment differs from the first embodiment in that, the system for playing sound data further includes a radio frequency identification 30 coupled to a first sound play apparatus 10, and a first radio frequency circuit 11 is coupled between the radio frequency identification 30 and a first play circuit 12, and an output end of the first radio frequency circuit 11 is coupled to an input end of the first play circuit 12.

The radio frequency identification 30 is configured to store a piece of time information (for ease of description, the time information is referred to as first time information T1). The pre-stored first time information T1 corresponds to a play time point of sound data. The first radio frequency circuit 11 reads the radio frequency identification to receive the first time information T1, and transmits the first time information T1 to the first play circuit 12. After receiving the first time information T1, the first play circuit 12 plays the sound data according to the play time point, corresponding to the first time information T1, of the sound data. That is, the first play circuit 12 may start to play the sound data at any start position of the sound data.

After the first play circuit 12 starts to play the sound data according to the first time information T1, a first control circuit 13 generates another piece of time information according to a current play time point of the sound data in the first play circuit 12 (for ease of description, the another piece of time information is referred to as second time information T2). The first radio frequency circuit 11 sends the second time information T2 to a second radio frequency circuit 21. The second radio frequency circuit 21 transmits the second time information T2 to a second play circuit 22. The second play circuit 22 may play the sound data according to the play time point, corresponding to the second time information T2, of the sound data.

On this basis, assuming that the play time point of the first time information T1 is the 0^{th} second, and the play time point corresponding the second time information T2 is the 20^{th} second, the first play circuit 12 starts to play the sound data at the 0^{th} second of the sound data, and the second play circuit 22 starts to play the sound data at the 20^{th} second of the sound data. In other words, starting from the 20^{th} second of the sound data, the second play circuit 22 and the first play circuit 12 synchronously play the sound data.

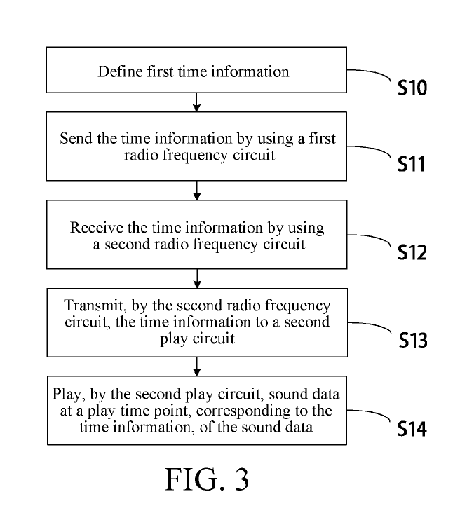

FIG. 3 is a flowchart of a first embodiment of a method for playing sound data according to the present invention. Referring to both FIG. 1 and FIG. 3, first, a piece of time information is defined (step S10), where the time information corresponds to a play time point of a piece of sound data; the time information T is sent by using a first radio frequency circuit 11 (step S11); the time information T is received by using a second radio frequency circuit 21 (step S12), and the second radio frequency circuit 21 transmits the time information T to a second play circuit 22 (step S13), so that the second play circuit 22 plays the sound data at the play time point, corresponding to the time information T, of the sound data (step S14). A radio frequency of the time information sent by the first radio frequency circuit 11 is less than 30 MHz.

In some implementation aspects, the time information T corresponds to a current play time point of the sound data in a first play circuit 12. Therefore, before step S11 is performed, the current play time point of the sound data in the first play circuit 12 is counted to generate a count value as the time information T. In this way, the second play circuit 22 and the first play circuit 12 may synchronously play the sound data.

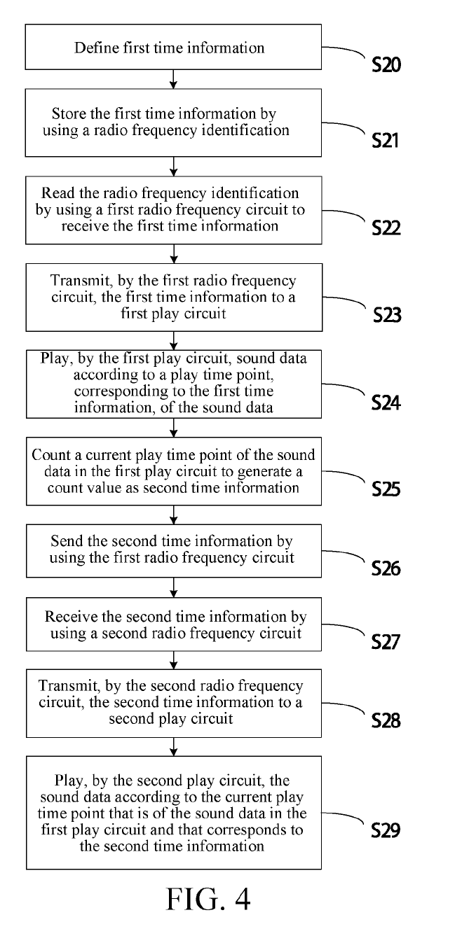

FIG. 4 is a flowchart of a second embodiment of a method for playing sound data according to the present invention. Referring to both FIG. 2 and FIG. 4, a piece of time information, referred to as first time information T1, is defined (step S20), where the first time information T1 corresponds to a play time point of sound data; the first time information T1 is stored by using a radio frequency identification 30 (step S21), and the radio frequency identification is read by using the first radio frequency circuit 11 to receive the first time information T1 (S22); the first radio frequency circuit 11 transmits the first time information T1 to a first play circuit 12 (step S23), so that the first play circuit 12 plays the sound data according to the play time point, corresponding to the first time information T1, of the sound data (step S24).

In some implementation aspects, the first time information T1 corresponds to a current play time point of the sound data in the first play circuit 12. Therefore, after step S24 is performed, the current play time point of the sound data in the first play circuit 12 is counted to generate a count value as second time information T2 (step S25); the second time information T2 is sent by using the first radio frequency circuit 11 (step S26), and is received by using the second radio frequency circuit 21 (step S27); the second radio frequency circuit 21 transmits the second time information T2 to the second play circuit 22 (step S28), so that the second play circuit 22 plays the sound data according to the current play time point that is of the sound data in the first play circuit 12 and that corresponds to the second time information T2 (step S29).

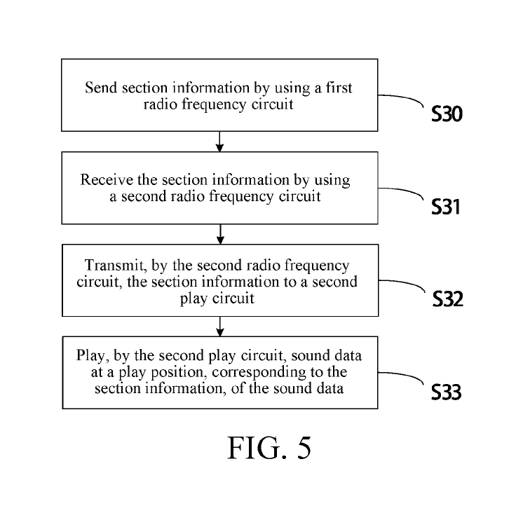

FIG. 5 is a flowchart of a third embodiment of a method for playing sound data according to the present invention. Referring to both FIG. 1 and FIG. 5, in this embodiment, to-be-played sound information includes a plurality of sections. Each section includes a note, a rest, an accidental, or a combination thereof. On this basis, a piece of section information is sent by using a first radio frequency circuit 11 (step S30), where the section information may be a code, which may correspond to a track, a note, a rest, an accidental, or a combination thereof of a specified section of the foregoing sound information. That is, the section information may correspond to a play position of the sound information, and the section information is received by using a second radio frequency circuit 21 (step S31), and the second radio frequency circuit 21 transmits the section information to a second play circuit 22 (step S32), and the second play circuit 22 plays the sound data by using the play position corresponding to the section information (step S33). The section information sent by the first radio frequency circuit 11 is a radio frequency signal, and a radio frequency thereof is less than 30 MHz.

In this embodiment, before step S33 is performed, the method for playing sound data further includes comparing the section information with a plurality of sections of the sound data, to obtain the play position corresponding to the section information. For example, by using that the section information is a code as an example, a plurality of sections in sound information correspond to different codes, and a code corresponding to the section information is separately compared with the codes corresponding to the sections to obtain a play position corresponding to the section information.

In some implementation aspects, the section information corresponds to a current play time point of the sound data in a first play circuit 12. Therefore, before step S30 is performed, a current section of the sound data in the first play circuit 12 may be counted to generate a code corresponding to the section information. In this way, the second play circuit 22 and the first play circuit 12 may synchronously play the sound data.

Based on the above, according to the method for playing sound data of the present invention, time information may be sent by using a radio frequency circuit, where the time information corresponds to a play time point of a piece of sound data, so that a play circuit that receives the time information plays the sound data according to any play time point corresponding to the time information, even different play circuits can synchronously play the sound data, thereby improving the convenience in life.

Although the present invention has been disclosed above by using embodiments, the embodiments are not intended to limit the present invention. Any person of ordinary skill in the art can make some changes and modifications without departing from the spirit and scope of the present invention. However, these changes and modifications should all be included in the protection scope of the appended claims of the present invention.

### INDUSTRIAL APPLICABILITY

According to the method for playing sound data of the present invention, time information may be sent by using a radio frequency circuit, where the time information corresponds to a play time point of a piece of sound data, so that a play circuit that receives the time information plays the sound data according to any play time point corresponding to the time information, even different play circuits can synchronously play the sound data, thereby improving the convenience in life.

1. A method for playing sound data, comprising:
defining a piece of time information, wherein the time information corresponds to a play time point of a piece of sound data;
sending the time information by using a first radio frequency circuit;
receiving the time information by using a second radio frequency circuit, and transmitting the time information to a play circuit coupled to the second radio frequency circuit; and
playing, by the play circuit, the sound data at the play time point corresponding to the time information.

2. The method for playing sound data according to claim 1, wherein the first radio frequency circuit is coupled to another play circuit, and the time information sent by the first radio frequency circuit corresponds to a current play time point of the sound data in the another play circuit.

3. The method for playing sound data according to claim 2, further comprising: counting the current play time point of the sound data in the another play circuit to generate a count value as the time information.

4. The method for playing sound data according to claim 1, wherein a radio frequency of the time information sent by the first radio frequency circuit is less than 30 MHz.

5. A method for playing sound data, comprising:
defining a piece of time information, wherein the time information corresponds to a play time point of a piece of sound data;
storing the time information by using a radio frequency identification;
reading the radio frequency identification by using a first radio frequency circuit to receive the time information, and transmitting the time information to a play circuit coupled to the radio frequency circuit; and
playing, by the play circuit, the sound data according to the play time point corresponding to the time information.

6. The method for playing sound data according to claim 5, wherein a radio frequency of the time information sent by the first radio frequency circuit is less than 30 MHz.

7. The method for playing sound data according to claim 5, further comprising:
sending another piece of time information by using the first radio frequency circuit, wherein the another piece of time information corresponds to a current play time point of the sound data in the play circuit.

8. The method for playing sound data according to claim 7, further comprising: counting the current play time point of the sound data in the play circuit to generate a count value as the another piece of time information.

9. The method for playing sound data according to claim 7, further comprising:
receiving the another piece of time information by using a second radio frequency circuit, and transmitting the another piece of time information to another play circuit coupled to the second radio frequency circuit; and
playing, by the another play circuit, the sound data according to the current play time point that is of the sound data in the play circuit and that corresponds to the another piece of time information.

10. A system for playing sound data, comprising:
a first radio frequency circuit, configured to send a piece of time information, wherein the time information corresponds to a play time point of a piece of sound data;
a second radio frequency circuit, configured to receive the time information; and
a play circuit, coupled to the second radio frequency circuit, and configured to play the sound data at the play time point corresponding to the time information.

11. The system for playing sound data according to claim 10, further comprising another play circuit coupled to the first radio frequency circuit, wherein the time information corresponds to a current play time point of the sound data in the another play circuit.

12. The system for playing sound data according to claim 11, further comprising a control circuit coupled to the another play unit, wherein the control circuit is configured to count the current play time point of the sound data in the another play circuit to generate a count value as the time information.

13. The system for playing sound data according to claim 10, wherein a radio frequency of the time information sent by the first radio frequency circuit is less than 30 MHz.

14. A system for playing sound data, comprising:
a radio frequency identification, configured to store a piece of time information, wherein the time information corresponds to a play time point of a piece of sound data;
a first radio frequency circuit, configured to read the radio frequency identification to receive the time information; and
a play circuit, coupled to the first radio frequency circuit, and configured to receive the time information, and play the sound data according to the play time point corresponding to the time information.

15. The system for playing sound data according to claim 14, wherein a radio frequency of the time information sent by the first radio frequency circuit is less than 30 MHz.

16. The system for playing sound data according to claim 14, wherein the first radio frequency circuit is further configured to send another piece of time information, and the another piece of time information corresponds to a current play time point of the sound data in the play circuit.

17. The system for playing sound data according to claim 16, further comprising a second radio frequency circuit and another play circuit coupled to the second radio frequency circuit, wherein the second radio frequency circuit is configured to receive the another piece of time information and transmit the another piece of time information to another play circuit, and the another play circuit is configured to play the sound data according to the current play time point that is of the sound data in the play circuit and that corresponds to the another piece of time information.

18. A method for playing sound data, applicable to playing a piece of sound information, and comprising:
sending a piece of section information by using a first radio frequency circuit, wherein the section information corresponds to a play position of the sound data;
receiving the section information by using a second radio frequency circuit, and transmitting the section information to a play circuit coupled to the second radio frequency circuit; and
playing, by the play circuit, the sound data at the play position corresponding to the section information.

19. The method for playing sound data according to claim 18, wherein the sound data comprises a plurality of sections, and the method for playing sound data further comprises: comparing the section information with the sections of the sound data, to obtain the play position corresponding to the section information.

20. The method for playing sound data according to claim 18, wherein the first radio frequency circuit is coupled to another play circuit, and the section information sent by the first radio frequency circuit corresponds to a current play position of the sound data in the another play circuit.

21. The method for playing sound data according to claim 18, wherein a radio frequency of the section information sent by the first radio frequency circuit is less than 30 MHz.
